(19) United States
(12) Patent Application Publication
(10) Pub. No.: US 2013/0302680 A1
(43) Pub. Date: Nov. 14, 2013

(54) ANODE ACTIVE MATERIAL AND THE SECONDARY BATTERY COMPRISING THE SAME

(71) Applicant: LG CHEM, LTD., Seoul (KR)

(72) Inventors: SooHyun LIM, Daejeon (KR); SeongMin LEE, Seoul (KR)

(21) Appl. No.: 13/865,593

(22) Filed: Apr. 18, 2013

(30) Foreign Application Priority Data
Apr. 18, 2012 (KR) 10-2012-0040286

(51) Int. Cl. H01M 4/36; H01M 4/62

(52) U.S. Cl. CPC H01M 4/366; H01M 4/62
USPC 429/213; 429/231.95; 429/231.1; 429/220; 429/228; 429/231; 429/221

(57) ABSTRACT

Disclosed is an anode active material comprising a lithium metal oxide represented by the following Formula 1, wherein the anode active material is surface-coated with a silane compound and a silicon content of the silane compound is 0.01 to 5% by weight, based on the total amount of the anode active material:

LiₐM′_{b}O_{4-c}A_{c} (1)
wherein M′ is at least one element selected from the group consisting of Ti, Sn, Cu, Pb, Sb, Zn, Fe, In, Al and Zr;
a and b are determined according to an oxidation number of M′ within ranges of 0.1≦a≦4 and 0.2≦b≦4;
c is determined according to an oxidation number within a range of 0≦c<0.2; and
A is at least one monovalent or bivalent anion.

Disclosed is also a secondary battery comprising the same.

### TECHNICAL FIELD

The present invention relates to a cathode active material and a secondary battery comprising the same. More specifically, the present invention relates to a cathode active material comprising a lithium nickel manganese composite oxide with a spinel structure represented by the following Formula 1, wherein the cathode active material is surface-coated with a silane compound and a silicon content of the silane compound is 0.01 to 5% by weight, based on the total amount of the cathode active material, and a secondary battery comprising the same:

LiₓM_{y}Mn_{2-y}O_{4-z}A_{z} (1)

wherein 0.95≦x≦1.2, 0<y<2, and 0≦z<0.2;

M is at least one element selected from the group consisting of Al, Mg, Ni, Co, Fe, Cr, V, Ti, Cu, B, Ca, Zn, Zr, Nb, Mo, Sr, Sb, W, Ti and Bi; and

A is at least one monovalent or bivalent anion.

### BACKGROUND ART

An increase in technological development and demand associated with mobile equipment has led to a sharp increase in demand for secondary batteries as energy sources. Among these secondary batteries, lithium secondary batteries having high energy density and driving voltage, long lifespan and low self-discharge are commercially available and widely used.

In addition, in recent years, increased interest in environmental issues has brought about a great deal of research associated with electric vehicles (EVs) and hybrid electric vehicles (HEVs) as alternatives to vehicles using fossil fuels such as gasoline vehicles and diesel vehicles which are major causes of air pollution. Nickel metal hydride (Ni-MH) secondary batteries are generally used as power sources of electric vehicles (EVs), hybrid electric vehicles (HEVs) and the like. However, research associated with use of lithium secondary batteries having high energy density, high discharge voltage and power stability is actively underway and some of such lithium secondary batteries are commercially available.

A lithium secondary battery has a structure in which a non-aqueous electrolyte comprising a lithium salt is impregnated into an electrode assembly comprising a cathode and an anode, each comprising an active material coated on a current collector, and a porous separator interposed therebetween.

Currently, a carbon-based material is generally used as an anode for lithium secondary batteries. However, such carbon-based material has a potential of 0V, which is lower than that of lithium, thus disadvantageously inducing reduction of an electrolyte and causing generation of gas. In order to solve these problems, lithium titanium oxide (LTO) having a relatively high potential is also used as an anode active material.

Lithium titanium oxide is known as a zero-strain material that suffers minimal structural deformation during charge/discharge, exhibits considerably superior lifespan, does not cause generation of dendrites and has considerably superior safety and stability. In addition, lithium titanium oxide electrodes are very advantageous due to their rapid charging time of several minutes. However, an electrode produced using LTO may cause decomposition of moisture contained therein, thus generating large amounts of gas, since LTO readily absorbs moisture in air. Such gas may deteriorate battery safety.

Accordingly, there is an increasing need for methods of ultimately solving these problems.

### DISCLOSURE

### Technical Problem

Therefore, the present invention has been made to solve the above and other technical problems that have yet to be resolved.

As a result of a variety of extensive and intensive studies and experiments, the present inventors discovered that desired effects, can be obtained by using an anode active material comprising a specific lithium metal oxide surface-coated with a predetermined amount of silane compound. The present invention has been completed, based on this discovery.

### Technical Solution

In accordance with one aspect of the present invention, provided is an anode active material comprising a lithium metal oxide represented by the following Formula 1, wherein the anode active material is surface-coated with a silane compound and a silicon content of the silane compound is 0.01 to 5% by weight, based on the total amount of the anode active material, and a secondary battery comprising the same:

LiₐM′_{b}O_{4-c}A_{c} (1)

wherein M′ is at least one element selected from the group consisting of Ti, Sn, Cu, Pb, Sb, Zn, Fe, In, Al and Zr;

a and b are determined according to an oxidation number of M′ within ranges of 0.1≦a≦4 and 0.2≦b≦4;

c is determined according to an oxidation number within a range of 0≦c<0.2; and

A is at least one monovalent or bivalent anion.

Generally, decomposition of an electrolyte is accelerated by side reaction between the anode active material and the electrolyte, and gas is thus generated. Such gas causes safety issues in the secondary battery, for example, swelling or explosion thereof.

Accordingly, the anode active material according to the present invention comprises a silane compound coated on the surface thereof, thus preventing moisture absorbance in the process of producing an electrode and a battery, thus advantageously eliminating the necessity of moisture control and drying processes in terms of control and process of lithium titanium oxide and improving processability.

In one embodiment, the silane compound may be represented by the following Formula a:

R₁—Si(R₂)(R₃)—R₄ (a)

wherein one or more of R₁, R₂, R₃ and R₄ are each independently hydrogen, a halogen, alkylamino, dialkylamino, alkyl alcohol, C₁-C₂₀ alkyl, C₁-C₂₀ alkenyl, C₁-C₂₀ alkynyl, C₁-C₂₀ alkoxy, C₁-C₂₀ alkoxy carbonyl, C₁-C₂₀ acyl, C₃-C₂₀ cycloalkyl, C₆-C₁₈ aryl, C₂-C₁₈ allyl, nitrile, silazane or phosphate.

More specifically, in the silane compound of Formula a, one or more of R₁ to R₃ are a halogen, silazane, C₁-C₂₀ alkoxy, C₆-C₁₈ aryl or C₂-C₁₈ allyl, and R₄ is C₁-C₂₀ alkyl, nitrile, fluorine or phosphate, and more specifically, R₁ and R₂ are a halogen, silazane, C₁-C₂₀ alkoxy, C₆-C₁₈ aryl or C₂-C₁₈ allyl, and R₃ and R₄ are C₁-C₂₀ alkyl, nitrile, fluorine or phosphate.

In another embodiment, in the silane compound of Formula a, one or more of R₁ to R₃ are C₁-C₂₀ alkyl, C₁-C₂₀ alkoxy or C₂-C₁₈ allyl, and R₄ is silazane.

The silazane defined above refers to all compounds having a Si—Ni—Si bond and may be referred to as disilazane or trisilazane, depending on the number of silicon atoms. The alkylamino, dialkylamino, alkyl, alkenyl, alkynyl, alkoxy, alkoxy carbonyl, acyl, cycloalkyl, aryl and the like defined above are well known in the art and a detailed definition thereof is thus omitted.

Specifically, the silane compound of Formula a may be hexamethyldisilazane represented by (Si(CH₃)₃)₂NH.

More specifically, a silicon content of the anode active material coated with the silane compound is 0.01 to 3% by weight, based on the total weight of the anode active material. When the silicon content is excessively low, the effect of preventing electrolyte oxidation by formation of the coating layer cannot be obtained, and when the content of silicon is excessively high, the coating layer becomes excessively thick, an internal resistance greatly increases, side reaction occurs and performance of battery may be deteriorated.

A method of application to form the coating layer may be any method of applying a predetermined material on the surface of an active material which is well known in the art. For example, the application may be carried out in a dry or wet manner.

The oxide of Formula 1 is represented by the following Formula 2:

LiₐTi_{b}O₄ (2)

wherein 0.1≦a≦4 and 0.2≦b≦4.

The lithium metal oxide may be Li_{1.33}Ti_{1.67}O₄ or LiTi₂O₄.

The present invention provides a secondary battery comprising the anode active material.

For example, the secondary battery according to the present invention comprises a cathode produced by applying a mixture containing a cathode active material, a conductive material and a binder to a cathode current collector, followed by drying and pressing, and an anode produced by the same method as the cathode. In this case, the mixture may further comprise a filler, as necessary.

The cathode current collector is generally fabricated to have a thickness of 3 to 500 μm. There is no particular limit as to the cathode current collector, so long as it has suitable conductivity without causing adverse chemical changes in the fabricated battery. Examples of the cathode current collector include stainless steel, aluminum, nickel, titanium, sintered carbon, and aluminum or stainless steel surface-treated with carbon, nickel, titanium or silver. If necessary, these current collectors may be processed to form fine irregularities on the surface thereof so as to enhance adhesion to the cathode active materials. In addition, the current collectors may be used in various forms including films, sheets, foils, nets, porous structures, foams and non-woven fabrics.

Examples of the cathode active material include: layered compounds such as lithium cobalt oxide (LiCoO₂) and lithium nickel oxide (LiNiO₂) or these compounds substituted by one or more transition metals; lithium manganese oxides represented by Li₁₊ₓMn₂₋ₓO₄ (in which 0≦x≦0.33), LiMnO₃, LiMn₂O₃ and LiMnO₂; lithium copper oxide (Li₂CuO₂); vanadium oxides such as LiV₃O₈, LiFe₃O₄, V₂O₅ and Cu₂V₂O₇; Ni-site type lithiated nickel oxides represented by LiNi₁₋ₓMₓO₂ (M=Co, Mn, Al, Cu, Fe, Mg, B or Ga, and 0.01≦x≦0.3); lithium manganese composite oxides represented by LiMn₂₋ₓMₓO₂ (M=Co, Ni, Fe, Cr, Zn or Ta, and 0.01≦x≦0.1), or Li₂Mn₃MO₈ (M=Fe, Co, Ni, Cu or Zn); lithium manganese composite oxide with a spinel structure, represented by LiNiₓMn₂₋ₓO₄; LiMn₂O₄ wherein a part of Li is substituted by an alkaline earth metal ion; disulfide compounds; and Fe₂(MoO₄)₃. Specifically, the cathode active material may comprise a lithium metal oxide represented by the following Formula 3:

LiₓM_{y}Mn_{2-y}O_{4-z}A_{z} (3)

wherein 0.9≦x≦1.2, 0<y<2, and 0≦z<0.2;

M is at least one element selected from the group consisting of Al, Mg, Ni, Co, Fe, Cr, V, Ti, Cu, B, Ca, Zn, Zr, Nb, Mo, Sr, Sb, W, Ti and Bi; and

A is at least one monovalent or bivalent anion.

The lithium metal oxide may be represented by the following Formula 4:

LiₓNi_{y}Mn_{2-y}O₄ (4)

wherein 0.9≦x≦1.2, and 0.4≦y≦0.5, preferably, 0.5≦a≦3 and 1≦b≦2.5.

More specifically, the lithium metal oxide may be LiNi_{0.5}Mn_{1.5}O₄ or LiNi_{0.4}Mn_{1.6}O₄.

The conductive material is commonly added in an amount of 1 to 50% by weight, based on the total weight of the mixture comprising the cathode active material. Any conductive material may be used without particular limitation so long as it has suitable conductivity without causing adverse chemical changes in the battery. Examples of conductive materials include: graphite such as natural graphite or artificial graphite; carbon black such as carbon black, acetylene black, Ketjen black, channel black, furnace black, lamp black and thermal black; conductive fibers such as carbon fibers and metallic fibers; metallic powders such as carbon fluoride powders, aluminum powders and nickel powders; conductive whiskers such as zinc oxide and potassium titanate; conductive metal oxides such as titanium oxide; and conductive materials such as polyphenylene derivatives.

The binder is a component enhancing binding of an electrode active material to the conductive material and the current collector. The binder is commonly added in an amount of 1 to 50% by weight, based on the total weight of the mixture comprising the cathode active material. Examples of the binder include polyvinylidene fluoride, polyvinyl alcohol, carboxymethylcellulose (CMC), starch, hydroxypropylcellulose, regenerated cellulose, polyvinyl pyrrolidone, tetrafluoroethylene, polyethylene, polypropylene, ethylene propylene diene terpolymer (EPDM), sulfonated EPDM, styrene butadiene rubbers, fluororubbers and various copolymers.

The filler is a component optionally used to inhibit expansion of the electrode. Any filler may be used without particular limitation so long as it does not cause adverse chemical changes in the manufactured battery and is a fibrous material. Examples of the filler include olefin polymers such as polyethylene and polypropylene; and fibrous materials such as glass fibers and carbon fibers.

The anode current collector is generally fabricated to have a thickness of 3 to 500 μm. There is no particular limit as to the anode current collector, so long as it has suitable conductivity without causing adverse chemical changes in the fabricated battery. Examples of the anode current collector include copper, stainless steel, aluminum, nickel, titanium, sintered carbon, and copper or stainless steel surface-treated with carbon, nickel, titanium or silver, and aluminum-cadmium alloys. Similar to the cathode current collector, the anode current collector may be processed to form fine irregularities on the surface thereof so as to enhance adhesion to the anode active material. In addition, the current collectors may be used in various forms including films, sheets, foils, nets, porous structures, foams and non-woven fabrics.

The lithium metal oxide (LiₓM_{y}O_{z}) defined above may be used as the anode active material and the anode active material may further comprise: carbon such as non-graphitized carbon and graphitized carbon; metal composite oxides such as LiₓFe₂O₃ (0≦x≦1), LiₓWO₂ (0≦x≦1) and SnₓMe₁₋ₓMe′_{y}O_{z} (Me: Mn, Fe, Pb, Ge; Me′: Al, B, P, Si, Group I, II and III elements of the Periodic Table, halogen atoms; 0<x≦1; 1≦y≦3; and 1≦z≦8); lithium metal; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; Li—Co—Ni based materials; and titanium oxide. This material may be present in an amount of 1 to 30% by weight, based on the total weight of the anode active material.

The secondary battery may be a lithium secondary battery in which a lithium salt-containing electrolyte is impregnated into an electrode assembly having a structure in which a separator is interposed between a cathode and an anode.

The separator is interposed between the cathode and the anode. As the separator, an insulating thin film having high ion permeability and mechanical strength is used. The separator typically has a pore diameter of 0.01 to 10 μm and a thickness of 5 to 300 μm. As the separator, sheets or non-woven fabrics made of an olefin polymer such as polypropylene and/or glass fibers or polyethylene, which have chemical resistance and hydrophobicity, are used. When a solid electrolyte such as a polymer is employed as the electrolyte, the solid electrolyte may also serve as both the separator and the electrolyte.

The lithium salt-containing, non-aqueous electrolyte is composed of an electrolyte and a lithium salt. Examples of the electrolyte include, but are not limited to, a non-aqueous organic solvent, an organic solid electrolyte and an inorganic solid electrolyte.

Examples of the non-aqueous organic solvent include non-protic organic solvents such as N-methyl-2-pyrrolidinone, propylene carbonate, ethylene carbonate, butylene carbonate, dimethyl carbonate, diethyl carbonate, gamma-butyrolactone, 1,2-dimethoxy ethane, franc, 2-methyl tetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxy methane, dioxolane derivatives, sulfolane, methyl sulfolane, 1,3-dimethyl-2-imidazolidinone, propylene carbonate derivatives, tetrahydrofuran derivatives, ethers, methyl propionate and ethyl propionate.

Examples of the organic solid electrolyte include polyethylene derivatives, polyethylene oxide derivatives, polypropylene oxide derivatives, phosphoric acid ester polymers, polyagitation lysine, polyester sulfide, polyvinyl alcohols, polyvinylidene fluoride, and polymers containing ionic dissociation groups.

Examples of the inorganic solid electrolyte include nitrides, halides and sulfates of lithium such as Li₃N, LiI, Li₅NI₂, Li₃N—LiI-LoOH, LiSiO₄, LiSiO₄—LiI—LiOH, Li₂SiS₃, Li₄SiO₄, Li₄SiO₄—LiI—LiOH and Li₃PO₄—Li₂S—SiS₂.

The lithium salt is a material that is readily soluble in the above-mentioned non-aqueous electrolyte and examples thereof include LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, chloroborane lithium, lower aliphatic carboxylic acid lithium, lithium tetraphenyl borate and imides.

Additionally, in order to improve charge/discharge characteristics and flame retardancy, for example, pyridine, triethylphosphite, triethanolamine, cyclic ether, ethylenediamine, n-glyme, hexaphosphoric triamide, nitrobenzene derivatives, sulfur, quinone imine dyes, N-substituted oxazolidinone, N,N-substituted imidazolidine, ethylene glycol dialkyl ether, ammonium salts, pyrrole, 2-methoxy ethanol, aluminum trichloride or the like may be added to the non-aqueous electrolyte. If necessary, in order to impart incombustibility, the non-aqueous electrolyte may further contain halogen-containing solvents such as carbon tetrachloride and ethylene trifluoride. Further, in order to improve high-temperature storage characteristics, the non-aqueous electrolyte may further contain carbon dioxide gas or the like and may further contain fluoro-ethylene carbonate (FEC), propene sulfone (PRS) and the like.

For example, the lithium salt-containing non-aqueous electrolyte can be prepared by adding a lithium salt such as LiPF₆, LiClO₄, LiBF₄ and LiN(SO₂CF₃)₂, to a mixed solvent of a cyclic carbonate such as EC or PC as a highly dielectric solvent and a linear carbonate such as DEC, DMC or EMC as a low-viscosity solvent.

The present invention provides a battery module comprising the secondary battery as a unit battery and a battery pack comprising the battery module.

The battery pack may be used as a power source for medium to large devices requiring high-temperature stability, long cycle properties and high rate properties.

Preferably, examples of the medium to large devices include, but are not limited to, power tools powered by battery-driven motors; electric vehicles including electric vehicles (EVs), hybrid electric vehicles (HEVs) and plug-in hybrid electric vehicles (PHEVs); electric two-wheeled vehicles including electric bikes (E-bikes) and electric scooters (E-scooters); electric golf carts; power storage systems and the like.

### Effects of the Invention

As apparent from the foregoing, the anode active material according to the present invention comprises a lithium metal oxide having a spinel structure which is coated to a predetermined thickness with a silane compound, thus preventing generation of gas and by-products caused by decomposition of an electrolyte during charge and discharge of batteries, and a secondary battery comprising the cathode active material thus exerts superior safety.

The anode active material advantageously eliminates the necessity of moisture control and drying processes and thus improves processability in terms of control and process of lithium titanium oxide.

### BRIEF DESCRIPTION OF THE DRAWINGS

The patent or application file contains at least one color drawing. Copies of this patent or patent application publication with color drawing will be provided by the USPTO upon request and payment of the necessary fee.

The above and other objects, features and other advantages of the present invention will be more clearly understood from the following detailed description taken in conjunction with the accompanying drawings, in which:

FIG. 1 is a graph showing an amount of gas generated during charge and discharge of a secondary battery according to Experimental Example 2.

### DETAILED DESCRIPTION OF THE INVENTION

Now, the present invention will be described in more detail with reference to the following examples. These examples are provided only to illustrate the present invention and should not be construed as limiting the scope and spirit of the present invention.

### Example 1

An anode active material was prepared by coating the surface of a Li_{1.33}Ti_{1.67}O₄ powder with hexamethyldisilazane such that a content of silicon present on the surface of Li_{1.33}Ti_{1.67}O₄ was 0.05% by weight, with respect to the total amount of the anode active material and then removing unreacted and remaining hexamethyldisilazane residue using MC.

### Comparative Example 1

An anode active material comprising Li_{1.33}Ti_{1.67}O₄ not coated with a silane compound was prepared.

### Comparative Example 2

An anode active material was prepared in the same manner as in Example 1, except that the surface of Li_{1.33}Ti_{1.67}O₄ was coated with hexamethyldisilazane such that a content of silicon present on the surface of Li_{1.33}Ti_{1.67}O₄ was 10% by weight, with respect to the total amount of the anode active material.

### Experimental Example 1

Moisture contents of the anode active materials prepared in Example 1 and Comparative Examples 1 and 2 were measured. The results are shown in Table 1 below.

TABLE 1

| | Ex. 1 | Comp. Ex. 1 | Comp. Ex. 2 |
|---|---|---|---|
| Moisture content | 995.8 | 2249.5 | 970.3 |
| (ppm) | | | |

As can be seen from Table 1, the anode active material coated with hexamethyldisilazane prevented moisture absorbance owing to the coating layer, thus considerably reducing gas generation caused by decomposition of absorbed moisture.

### Experimental Example 2

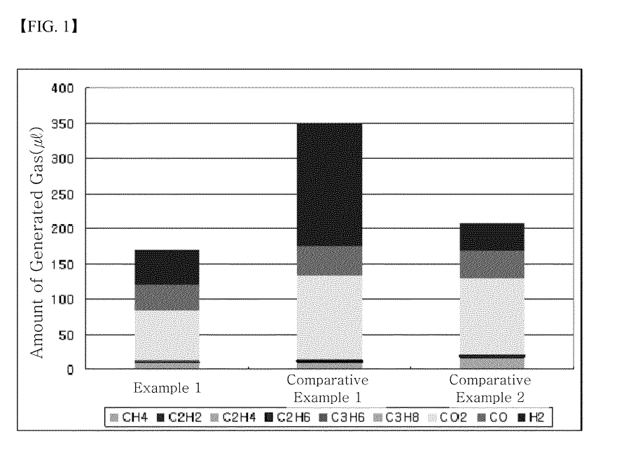

95% by weight of each of anode active materials prepared in Example 1 and Comparative Example 1, 5% by weight of Super-C (conductive material) and 5% by weight of PVdF (binder) were added to NMP to prepare an anode mix, and the anode mix was applied to an aluminum current collector, followed by drying and pressing, to produce an anode. 90% by weight of LiNi_{0.5}Mn_{1.5}O₄, 5% by weight of Super-C (conductive material) and 5% by weight of PVdF (binder) were added to NMP to prepare a cathode mix and the cathode mix was applied to an aluminum current collector, followed by drying and pressing, to produce a cathode. An electrode assembly was produced by inserting a porous separator made of polypropylene between the cathode and the anode. Then, the electrode assembly was inserted into a pouch, a lead line was connected thereto, and a solution of 1M LiPF₆ in a mixed solvent consisting of ethylene carbonate (EC), dimethyl carbonate (DMC), and ethyl methyl carbonate (EMC) at a volume ratio of 1:1:1 was injected as an electrolyte and sealed to assemble a lithium secondary battery. The secondary battery was stored at 55° C. for four weeks while undergoing charge and discharge cycling and gas generation was measured. The amount of gas generated is shown in Table 2 and FIG. 1.

TABLE 2

| | Ex. 1 | Comp. Ex. 1 | Comp. Ex. 2 |
|---|---|---|---|
| Amount of | 170.1 | 351.3 | 280.3 |
| generated gas (μl) | | | |

As can be seen from Table 2 and FIG. 1, the battery of Example 1 prevented moisture absorbance in the process of producing an electrode and a battery due to the silane compound coating layer formed on the surface of the anode active material, exhibited a considerable decrease in amount of generated gas via moisture decomposition and exhibited improved performance, as compared to the battery of Comparative Example 1. On the other hand, the battery of Comparative Example 2 generated a great amount of side reaction by-products due to excess silane compound present on the surface of the anode active material, thus generating much more gas than the battery of Example 1 and representing a serious safety hazard.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An anode active material comprising a lithium metal oxide represented by the following Formula 1,
wherein the anode active material is surface-coated with a silane compound and a silicon content of the silane compound is 0.01 to 5% by weight, based on the total amount of the anode active material:
LiₐM′_{b}O_{4-c}A_{c} (1)
wherein M′ is at least one element selected from the group consisting of Ti, Sn, Cu, Pb, Sb, Zn, Fe, In, Al and Zr;
a and b are determined according to an oxidation number of M′ within ranges of 0.1≦a≦4 and 0.2≦b≦4;
c is determined according to an oxidation number within a range of 0≦c<0.2; and
A is at least one monovalent or bivalent anion.

2. The anode active material according to claim 1, wherein the silane compound is represented by the following Formula a:
R₁—Si(R₂)(R₃)—R₄ (a)
wherein one or more of R₁, R₂, R₃ and R₄ are each independently hydrogen, a halogen, alkylamino, dialkylamino, alkyl alcohol, C₁-C₂₀ alkyl, C₁-C₂₀ alkenyl, C₁-C₂₀ alkynyl, C₁-C₂₀ alkoxy, C₁-C₂₀ alkoxy carbonyl, C₁-C₂₀ acyl, C₃-C₂₀ cycloalkyl, C₆-C₁₈ aryl, C₂-C₁₈ allyl, nitrile, silazane or phosphate.

3. The anode active material according to claim 2, wherein in the silane compound of Formula a, one or more of R₁ to R₃ are a halogen, silazane or C₁-C₂₀ alkoxy, C₆-C₁₈ aryl, or C₂-C₁₈ allyl, and R₄ is C₁-C₂₀ alkyl, nitrile, fluorine or phosphate.

4. The anode active material according to claim 2, wherein, in the silane compound of Formula a, R₁ and R₂ are a halogen, silazane or C₁-C₂₀ alkoxy, C₆-C₁₈ aryl or C₂-C₁₈ allyl, and R₃ and R₄ are C₁-C₂₀ alkyl, nitrile, fluorine or phosphate.

5. The anode active material according to claim 2, wherein, in the silane compound of Formula a, one or more of R₁ to R₃ are C₁-C₂₀ alkyl, C₁-C₂₀ alkoxy or C₂-C₁₈ allyl, and R₄ is silazane.

6. The anode active material according to claim 5, wherein the silane compound of Formula a is hexamethyldisilazane.

7. The anode active material according to claim 1, wherein a silicon content of the silane compound is 0.01 to 3% by weight, with respect to the total weight of the cathode active material.

8. The anode active material according to claim 1, wherein the lithium metal oxide is represented by the following Formula 2:
LiₐTi_{b}O₄ (2)
wherein 0.5≦a≦3 and 1≦b≦2.5.

9. The anode active material according to claim 8, wherein the lithium metal oxide is Li_{1.33}Ti_{1.67}O₄ or LiTi₂O₄.

10. A secondary battery comprising the anode active material according to claim 1.

11. The secondary battery according to claim 10, wherein the secondary battery is a lithium secondary battery.

12. A battery module comprising the secondary battery according to claim 10 as a unit battery.

13. A battery pack comprising the battery module according to claim 12.

14. A device comprising the battery pack according to claim 13.

15. The device according to claim 14, wherein the device is an electric vehicle, a hybrid electric vehicle, a plug-in hybrid electric vehicle or a power storage system.
